(19) United States
(12) Patent Application Publication
(10) Pub. No.: US 2005/0236728 A1
(43) Pub. Date: Oct. 27, 2005

(54) Open-cell polypropylene particle foams

(75) Inventors: Christian Maletzko, Altrip (DE); Franz-Josef Dietzen, Hassloch (DE); Uwe Keppeler, Hochdorf-Assenheim (DE); Frank Braun, Ludwigshafen (DE); Klaus Hahn, Kirchheim (DE); Isidor de Grave, Wachenheim (DE)

Correspondence Address: CONNOLLY BOVE LODGE & HUTZ LLP, SUITE 800, 1990 M STREET NW, WASHINGTON, DC, 20036-3425, US

(73) Assignee: BASF AKTIENGESELLSCHAFT, Ludwigshafen (DE)

(21) Appl. No.: 10/519,801

(22) PCT Filed: Jun. 30, 2003
(86) PCT No.: PCT/EP03/06895

§ 371 Date: Dec. 29, 2004

(30) Foreign Application Priority Data
Jul. 5, 2002 (DE) 102 30 583.8

(51) Int. Cl. B29C 44/02

(52) U.S. Cl. 264/51; 521/142

(57) ABSTRACT

The invention relates to foam beads of propylene polymers which comprise more than 40% of open cells. They are produced by impregnating propylene polymer minigranules which comprise from 1 to 40% by weight of a cell opener with a volatile blowing agent in aqueous suspension and subsequently decompressing the mixture.

The invention relates to open-celled foam beads based on propylene polymers.

Foam parts made from propylene polymers are increasingly being employed for parts in the interior of automobiles, as packaging materials and for leisure articles. They are obtained by post-expansion and sintering of corresponding foam beads. These are in turn produced by known processes (for example EP-A 95109) by impregnation of polypropylene granules in aqueous suspension with a volatile blowing agent in a pressure container, followed by decompression of the mixture. Foam beads produced in this way exhibit a so-called double peak in the DSC thermodiagram, i.e. at least one high-temperature peak at a higher temperature than the melting peak of the propylene polymer employed (see, for example, EP-A 415744). They are distinguished by particularly good processing properties and good mechanical properties, for example heat distortion resistance. Foam beads of this type normally have closed cells; for example, the foam beads according to EP-A 95109 have at least 65% of closed cells. This is also desired in most applications.

EP-A 1016690 describes foam beads made from propylene polymers which comprise water as blowing agent and from 0.05 to 10% by weight of a hydrophilic polymer, for example a polyamide, a polyester or polyvinyl alcohol. However, they comprise at least 85% of closed cells, i.e. are not open-celled.

Open-celled plastic foams are generally more elastic than closed-cell foams and have a sound-insulating action, which is advantageous, for example, for automobile interior trim and in some packaging materials. WO 00/15700 describes open-celled polyolefin foams having good sound-absorbing properties. They are boards, films or pipes produced by extrusion of a polyolefin melt together with a volatile organic blowing agent. In this foam extrusion, it is only possible to produce moldings having a simple geometry. In addition, the foams do not exhibit the above-described double peak in the DSC thermodiagram, and consequently, for example, their heat distortion resistance is inadequate for some applications.

It is an object of the present invention to provide open-celled foam beads based on propylene polymers which exhibit, in particular, good mechanical properties and can be further processed in a variety of ways.

We have found that this object is achieved by open-celled foam beads having a mean bead size of from 1 to 10 mm and a bulk density of from 5 to 200 g/l based on propylene polymers and having a proportion of open cells (in accordance with DIN ISO 4590) of greater than 40%.

A preferred process for the production of open-celled foam beads of this type comprises impregnating propylene polymer beads in aqueous suspension with a volatile blowing agent in a pressure container at elevated temperature, and subsequently decompressing the mixture. The propylene polymer beads comprise from 1 to 40% by weight of a cell opener, for example a polar, water-insoluble thermoplastic, a water-soluble polymer or a needle-shaped inorganic solid.

For the purposes of the present invention, propylene polymers are:
a. homopolypropylene,
b. random copolymers of propylene with up to 15% by weight of ethylene and/or 1-butene, preferably copolymers of propylene with 0.5 to 6% of ethylene or with from 0.5 to 12% by weight of 1-butene, or terpolymers of propylene, from 0.5 to 6% by weight of ethylene and from 0.5 to 6% by weight of 1-butene,
c. mixtures of a. or b. with from 0.1 to 75% by weight, preferably from 3 to 50% by weight, of a polyolefin elastomer, for example an ethylene-propylene block copolymer.

Propylene polymers produced either with Ziegler catalysts or with metallocene catalysts are suitable.

The crystalline melting point (DSC peak maximum) of the propylene polymers is between 120 and 170° C. Their enthalpy of melting, determined by the DSC method, is preferably between 50 and 110 J/g, and their melt flow index (MFI) (230° C., 2.16 kp) in accordance with DIN 53735 is between 2 and 25 g/10 min.

The open-celled foam beads according to the invention are produced starting from granules, which preferably have mean diameters of from 0.2 to 10 mm, in particular from 0.5 to 5 mm. These usually cylindrical or spherical minigranules are produced by extruding the propylene polymer together with the admixed cell opener and further additives, forcing the mixture out of the extruder, if desired cooling the mixture, and granulating the mixture.

It is essential that the minigranules comprise from 1 to 40% by weight, preferably from 5 to 35% by weight, of a cell opener. Preferred cell openers are polar, water-insoluble thermoplastics, preferably a polyamide (PA) or polyoxymethylene (POM); water-soluble polymers, preferably polyvinylpyrrolidone (PVP), polyvinyl acetate and polyethylene oxide; furthermore needle-shaped inorganic solids, preferably cut glass having a length of from 0.25 to 5 mm. In addition, the minigranules may comprise conventional additives, such as antioxidants, stabilizers, flame retardants, waxes, pigments, dyes and in particular nucleating agents, such as talc, graphite powder, pyrogenic silicic acids, zeolites, bentonites and polyolefin waxes.

The minigranules are dispersed in a suspension medium in a stirred reactor. The preferred suspension medium is water. In this case, suspension assistants have to be added in order to ensure uniform distribution of the minigranules in the suspension medium. Suitable suspension assistants are water-insoluble inorganic stabilizers, such as tricalcium phosphate, magnesium pyrophosphate and calcium carbonate; furthermore polyvinyl alcohol and surfactants, such as aryl sulfonates and fatty alcohol oxylates. They are employed in amounts of from 0.05 to 5% by weight, based on the minigranules. A volatile blowing agent is added to the suspension in amounts of from 2 to 50% by weight, preferably from 5 to 30% by weight, based on the minigranules. The blowing agent can be added before, during or after heating of the reactor contents. Suitable blowing agents are organic compounds having a boiling point of between −5 and 150° C., for example alkanes, ketones and ethers, as well as inorganic gases, such as nitrogen and carbon dioxide. Particular preference is given to C₄- to C₆-hydrocarbons.

During impregnation, the temperature should be in the vicinity of the softening point of the propylene polymer. It can be from 40° C. below to 15° C. above the melting point (crystalline melting point). Preferred impregnation temperatures are between 120° C. and 160° C. Depending on the type and amount of blowing agent and depending on the temperature level, a pressure which is generally greater than 2 bar and does not exceed 40 bar becomes established in the reactor. The impregnation times should generally be between 0.5 and 10 hours, after which the reactor is decompressed quickly. During this operation, the propylene polymer beads impregnated with blowing agent expand. Due to the cell opener, the open-celled foam beads according to the invention form in the process. After decompression and discharge from the reactor, the foam beads are separated from the suspension medium and washed. If a water-soluble cell opener was employed, this is substantially washed out at the same time. In the case of water-insoluble cell openers, these remain present in the foam beads.

The open-celled foam beads according to the invention have particularly good mechanical properties if they have, in the DSC melting diagram, at least one high-temperature peak at a higher temperature than the melting peak of the propylene polymer employed. The mean bead size of the foam beads is from 1 to 10 mm, preferably from 2 to 8 mm; their bulk density can be between 5 and 200 g/l, preferably between 10 and 100 g/l. They are characterized by a proportion of open cells (in accordance with DIN ISO 4590) of greater than 40%, preferably greater than 50% and in particular greater than 75%. In the ideal case, virtually all cells are open, i.e. the foam structure consists only of cell webs. The mean cell diameter is preferably from 0.01 to 0.5 mm, in particular from 0.05 to 0.3 mm.

Foam moldings can be produced from the foam beads according to the invention by known processes comprising post-expansion and sintering.

The parts (P) mentioned in the examples are by weight.

### EXAMPLES

P below denotes parts by weight.

Starting Materials:

PP1: Novolen 3200 MC; polypropylene from Basell GmbH
POM1: Ultraform N 2320 (BASF AG)
PA1: Ultramid B 3 (BASF AG)
PS1: standard polystyrene having M_{w}=195,000 g/mol, MVR=10 cm³/10 min (BASF AG)
PVP1: polyvinylpyrrolidone, Kollidon K 30 from BASF AG
Glass: cut glass 3786
Wax1: Luwax AF 31; polyethylene (Mn 3000) from BASF AG
Talc: HP 325
s-Pentane: technical-grade pentane isomer mixture
n/i-Butane: technical-grade butane isomer mixture
Antiblock1: CaCO₃;
Antiblock2: tricalcium phosphate
Surf1: fatty alcohol oxylate
Surf2: aryl sulfonate

Production of the Granules:

In order to produce the granules, the starting materials were mixed, fed to the extruder and converted into minigranules (d: 0.8-1.2 mm; I: 1.8-3 mm).
Gran1 (G1): 100 P of PP1, 20 P of POM1, 1 P of talc, 0.5 P of Wax1
Gran2 (G2): 100 P of PP1, 34 P of POM1, 2.8 P of talc, 0.5 P of Wax1
Gran3 (G3): 100 P of PP1, 25 P of glass, 0.5 P of Wax1
Gran4 (G4): 100 P of PP1, 20 P of PA1, 1 P of talc, 0.5 P of Wax1
Gran5 (G5): 100 P of PP1, 25 P of PVP1, 1.25 P of talc, 0.6 P of Wax1
Gran6 (G6): 100 P of PP1, 20 P of talc, 0.5 P of Wax1
Gran7 (G7): 100 P of PP1, 20 P of PS1, 1 P of talc, 0.5 P of Wax1
   Foaming of the Granules

The table shows the bulk densities achieved and the proportions of open cells measured on these foam beads. The proportion of open cells was determined on the foam beads in accordance with DIN ISO 4590.

### Examples 1 to 4

In each case, 100 P of granules, 6.7 P of Antiblock1, 0.13 P of Surf1, 230 P of water and the amount of n/i-butane indicated in the table were introduced into a pressure-tight stirred tank. The tank was then heated to the impregnation temperature (IMT) shown in the table over the course of about 55 minutes, and, when this temperature had been reached, the granules were foamed by decompressing the contents to ambient pressure.

### Examples 5 to 10

In each case, 100 P of granules, 8.75 P of Antiblock2, 0.33 P of Surf2, 234 P of water and the amount of n/i-butane indicated in the table were introduced into a pressure-tight stirred tank. The tank was then heated to the impregnation temperature (IMT) indicated in the table over the course of about 55 minutes, and, after this temperature had been reached, the granules were foamed by decompressing the contents to ambient pressure.

TABLE

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| Granules | G1 | G1 | G1 | G1 | G2 | G3 | G4 | G5 | G6 | G7 |
| IMT [° C.] | 129.0 | 129.0 | 128.7 | 127.6 | 128.0 | 127.5 | 130.0 | 129.0 | 130.0 | 136.0 |
| Blowing agent [P] | 24 | 20 | 20 | 20 | 24 | 24 | 35 | 24 | 35 | 16 |
| Bulk density [g/l] | 18 | 31 | 30 | 37 | 15 | 11 | 14 | 9 | 15 | 13 |
| Open cells [%] | 43 | 42 | 51 | 65 | 80 | 59 | 79 | 65 | 10 | 9 |

[P] = Parts by weight per 100 parts of PP minigranules
Examples 9 to 10 are comparative examples

1. Open-celled foam beads having a mean bead diameter of from 1 to 10 mm and a bulk density of from 5 to 200 g/l based on propylene polymers and having a proportion of open cells (in accordance with DIN ISO 4590) of greater than 40%.

2. Open-celled foam beads as claimed in claim 1, wherein the propylene polymer is a homopolymer or copolymer of propylene with up to 15% by weight of a monomer selected from the group consisting of ethylene and 1-butene and mixtures thereof.

3. Open-celled foam beads as claimed in claim 1, which have, in the DSC thermodiagram, at least one high-temperature peak at a higher temperature than the melting peak of the propylene polymer employed.

4. Open-celled foam beads as claimed in claim 1, wherein the mean cell diameter is from 0.01 to 0.5 mm.

5. Open-celled foam beads as claimed in claim 1, which have a content of from 1 to 40% by weight of a cell opener.

6. A process for the production of open-celled foam beads as claimed in claim 1 by impregnating propylene polymer beads in suspension with a volatile blowing agent in a pressure container at elevated temperature and subsequently decompressing the mixture, wherein the propylene polymer beads comprise from 1 to 40% by weight of a cell opener.

7. A process as claimed in claim 6, wherein the blowing agent is an organic compound having a boiling point of between −5 and 150° C.

8. A process as claimed in claim 6, wherein the cell opener is a polar, water-insoluble thermoplastic.

9. A process as claimed in claim 6, wherein the cell opener is a needle-shaped inorganic solid.

10. A process as claimed in claim 6, wherein the cell opener is a water-soluble polymer.

11. An open-celled foam molding produced by post-expansion and sintering of the foam beads as claimed in claim 1.

12. The process as claimed in claim 6, wherein said blowing agent is selected from the group consisting of C₄- to C₆-hydrocarbons and inorganic gases.

13. The process as claimed in claim 8, wherein said polar, water-insoluble thermoplastic is selected from the group consisting of polyamide and polyoxymethylene.

14. The process as claimed in claim 9, wherein said inorganic solid is cut glass having a length of from 0.25 to 5 mm.

15. The process as claimed in claim 10, wherein said water-soluble polymer is selected from the group consisting of polyvinylpyrrolidone, polyvinyl acetate, and polyethylene oxide.
